(19) United States
(12) Patent Application Publication
(10) Pub. No.: US 2020/0334191 A1
(43) Pub. Date: Oct. 22, 2020

(54) METHOD FOR PROCESSING MULTI-MEDIA SIGNALS AND ASSOCIATED MULTI-MEDIA DEVICE

(71) Applicant: Realtek Semiconductor Corp., HsinChu (TW)

(72) Inventors: Chao-Min Lai, Hsinchu City (TW); Chia-Hao Wu, Hsinchu City (TW); Yan-Jyun Chen, Changhua County (TW); Guo-Yuan Luo, Tainan City (TW)

(21) Appl. No.: 16/744,191

(22) Filed: Jan. 16, 2020

(30) Foreign Application Priority Data
Apr. 16, 2019 (TW) 108113180

(51) Int. Cl. G06F 13/42; H04N 21/4363; H04B 1/40; H04L 12/40

(52) U.S. Cl. CPC G06F 13/4282; H04L 12/40117; H04B 1/40; H04N 21/43635

(57) ABSTRACT

A method for processing a multi-media signal and an associated multi-media device are provided. The method includes: receiving a first audio signal within the multi-media signal from a display device through a first transmission interface of a multi-media device; converting the first audio signal into a second audio signal applicable to a second transmission interface of the multi-media device; and outputting the second audio signal to an audio device through the second transmission interface for playback.

### BACKGROUND OF THE INVENTION

### 1. Field of the Invention

The present invention is related to multi-media signals, and more particularly, to a method for processing a multi-media signal, and an associated multi-media device.

### 2. Description of the Prior Art

High Definition Multimedia Interface (HDMI) Licensing Administrator, Inc. (HDMI LA) specifies an Audio Return Channel (ARC) which allows audio signals to be transmitted indifferent directions. As transmission speed of signals reaches 12 Giga bits per second in the HDMI 2.1 specification, a length of HDMI cable is severely limited (e.g. 2-3 meters at most) under a condition of not introducing signal errors, which greatly limits locations of a projector (or TV) and an amplifier. Thus, there is a need for a novel multi-media signal processing method and associated multi-media device to solve the problem of limited cable length.

### SUMMARY OF THE INVENTION

An objective of the present invention is to provide a method for processing a multi-media signal and an associated multi-media device, which can prevent locations of a projector (or TV) and an amplifier from being limited by the length of an HDMI cable in order to improve user experience.

At least one embodiment of the present invention provides a method for processing a multi-media signal. The method comprises: receiving a first audio signal within the multi-media signal from a display device through a first transmission interface of a multi-media device; converting the first audio signal into a second audio signal applicable to a second transmission interface of the multi-media device; and outputting the second audio signal to an audio device through the second transmission interface for playback.

At least one embodiment of the present invention provides a multi-media device. The multi-media device comprises a first transmission interface, a second transmission interface and a system chip, wherein the system chip comprises a conversion circuit coupled between the first transmission interface and the second transmission interface. In operations of the multi-media device, the first transmission interface may be configured to receive a first audio signal within a multi-media signal from a display device, and the second transmission interface may be configured to output a second audio signal to an audio device for playback. In addition, the system chip may utilize the conversion circuit to convert the first audio signal into the second audio signal applicable to the second transmission interface.

The multi-media device of the present invention converts the first audio signal into the second audio signal, where a transmission length of the second audio signal is less likely to be limited by the length of HDMI cable. For example, the second transmission interface maybe implemented by a Universal Serial Bus (USB) interface in order to solve the related art problems of using HDMI cables. In addition, embodiments of the present invention will not greatly increase costs, so the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video system according to an embodiment of the present invention.

FIG. 2 is a diagram illustrating a video system according to an embodiment of the present invention.

FIG. 3 is a flowchart illustrating a method for processing a multi-media signal according to an embodiment of the present invention.

### DETAILED DESCRIPTION

At least one embodiment of the present invention provides a multi-media device. The multi-media device may utilize a video decoding circuit therein to perform video decoding to generate video output signals, and transmit the aforementioned video output signals to at least one video output device (e.g. digital TV, projector, etc.) through at least one High Definition Multimedia Interface (HDMI) cable. General digital TV performance has undergone recent improvements. For example, smart TVs can execute some video application programs (e.g. YouTube, Google Play and Netflix) which support high level audio specifications (e.g. Dolby Digital and Digital Theater System (DTS)). The multi-media device can support signal processing during execution of these video application programs, in order to allow users to enjoy the experience of using audio output equipment coupled to the multi-media device (e.g. audio output of the audio output equipment).

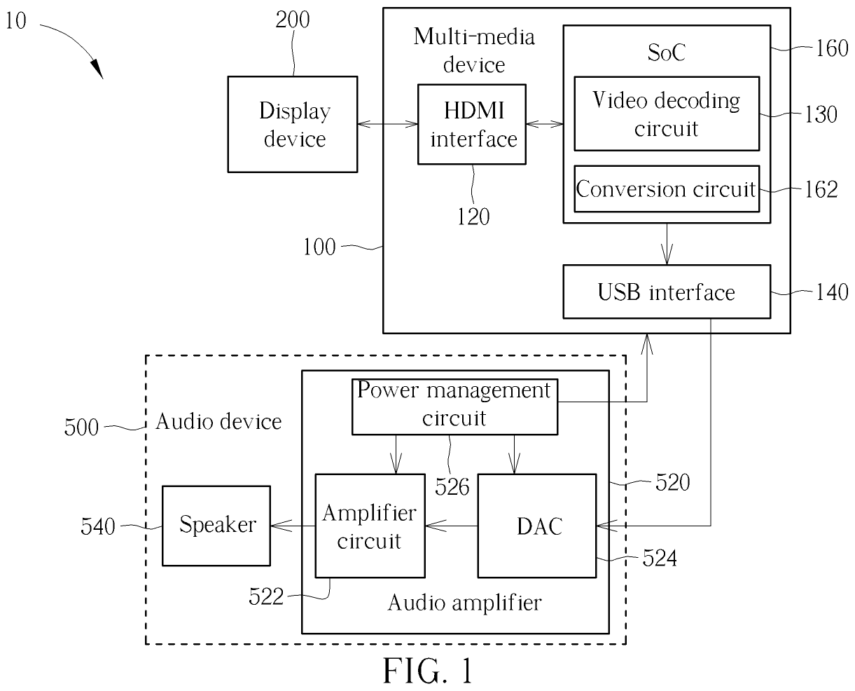

FIG. 1 is a diagram illustrating a video system 10 according to an embodiment of the present invention. The video system 10 may comprise a multi-media device 100, a display device 200 and an audio device 500, where examples of the display device 200 may include, but are not limited to: a display device without the function of executing the video application programs (such as a projector or a conventional TV), and a display device with the function of executing the video application programs (such as a smart TV); and examples of the audio device 500 may include, but are not limited to: an audio device integrating a speaker and an amplifier into a single device, and an audio system constituted by connecting a speaker and an amplifier. In some embodiments, the multi-media device 100 may be implemented in small sized multi-media devices such as an Over The Top (OTT) box and a TV stick.

In this embodiment, the multi-media device 100 may comprise a first transmission interface such as an HDMI interface 120, a video decoding circuit 130, a second transmission interface such as a Universal Serial Bus (USB) interface 140, and a system chip such as a System on a Chip (SoC) 160, where the SoC 160 may comprise a conversion circuit 162 coupled between the HDMI interface 120 and the USB interface 140. The HDMI interface 120 may allow the multi-media device 100 to be coupled to the display device 200 through an HDMI cable, and the USB interface 140 may allow the multi-media 100 to be coupled to the audio device 500 through at least one USB cable (e.g. a USB type-C cable). In some embodiments, in addition to the conversion circuit 162, the SoC 160 may further comprise one or more processing circuits (not shown) for executing various types of video application programs (e.g. YouTube, Google Play, Netflix, etc.), but the present invention is not limited thereto.

In this embodiment, the audio device 500 may comprise an audio amplifier 520 and a speaker 540 (e.g. a passive speaker) coupled to the audio amplifier, where the audio amplifier 520 may comprise an amplifier circuit 522, a digital-to-analog converter (DAC) 524 coupled to the amplifier circuit 522, and a power management circuit 526 respectively coupled to the amplifier circuit 522 and the DAC 524. In this embodiment, the DAC 524 may obtain a digital audio signal from the multi-media device 100 through the aforementioned at least one USB cable, and perform digital-to-analog conversion on the digital audio signal to output an analog audio signal; and then the amplifier circuit 522 may amplify the analog audio signal to drive the speaker 540 with the analog audio signal for playback; but the present invention is not limited thereto. In this embodiment, the power management circuit 526 may provide the amplifier circuit 522 and the DAC 524 with power, and may also provide the multi-media device 100 (such as the HDMI interface 120, the USB interface 140 and the SoC 160 therein) with power through the aforementioned at least one USB cable. Thus, the present invention provides a design of separated power sources, which makes the multi-media device 100 able to obtain power from the power management circuit 526 within the audio device 500 through at least one USB cable connecting the USB interface 140 to the audio device 500, to thereby allow the multi-media device 100 to normally operate without any built-in power management circuit, and required hardware size can be reduced.

In this embodiment, both the multi-media device 100 and the display device 200 have a function of obtaining streaming data (e.g. streaming data comprising image data and audio data) from a data streaming source. For better comprehension, the following description takes a smart TV as an example of the display device 200. When the display device 200 operates in an ordinary mode, the aforementioned streaming data is obtained from the data streaming source (e.g. a remote server or internet connected to the remote server) through the multi-media device 100 rather than through the display device 200, where the SoC 160 may utilize the video decoding circuit 130 to perform video decoding. In addition, the multi-media device 100 may utilize the HDMI interface 120 to transmit the image data within the streaming data to the display device 200 for display and utilize the USB interface 140 to transmit the audio data within the streaming data to the audio device 500 for playback. When the display device 200 operates in an internet mode, the aforementioned streaming data is obtained from the data streaming source (e.g. a remote server or internet connected to the remote server) through the display device 200 rather than through the multi-media device 100, where the SoC 160 may receive a first audio signal within a multi-media signal from the display device 200 through an Audio Return Channel (ARC) or an enhanced ARC (eARC) (e.g. the first audio signal may carry the audio data within the streaming data obtained by the display device 200), and then the SoC 160 may utilize the conversion circuit 162 therein to convert the first audio signal into a second audio signal applicable to the USB interface 140, and output the second audio signal to the audio device 500 through the USB interface 140 for playback.

In some embodiments, the conversion circuit 162 may comprise a decoder (not shown) to make the multi-media 100 able to process compressed audio data in addition to uncompressed audio data. For example, when the first audio signal (e.g. the audio data within the streaming data obtained by the display device 200 is audio data having Dolby Digital or Digital Theater System (DTS) format), the decoder within the conversion circuit 162 may decode (decompress) the audio data first, and then convert the decoded data into a USB signal format for being outputted by the USB interface 140; in another example, when the first audio signal is uncompressed audio data, the conversion circuit 162 may skip the aforementioned decoding step and directly convert the uncompressed data into a USB signal format for being outputted by the USB interface 140; but the present invention is not limited thereto.

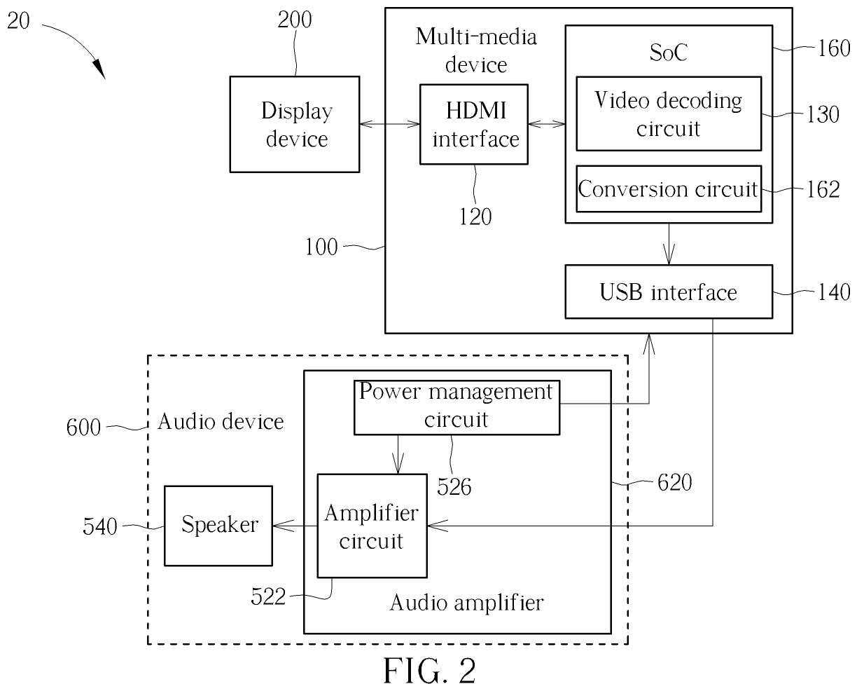

FIG. 2 is a diagram illustrating a video system 20 according to an embodiment of the present invention, where the USB interface 140 within the multi-media device 100 may comprise a USB type-C interface. A difference between this embodiment and the embodiment shown in FIG. 1 is that the audio device 600 connected to the multi-media device 100 does not comprise the DAC 524, and the audio device 600 is implemented by merely utilizing the power management circuit 526, the amplifier circuit 522 (e.g. a class-D amplifier) and the speaker 540. In comparison with the audio device 500, an audio signal received by the audio device 600 is an analog audio signal rather than a digital signal. In this embodiment, the USB interface 140 may determine whether the audio device 600 is an audio device without any DAC (e.g. a passive audio device) by detecting a set of input resistors (e.g. a set of resistors of configuration channel (CC) pins) of the audio device 600 (amplifier circuit), e.g. by detecting voltage levels corresponding to resistances of the set of resistors; wherein when the audio device 600 is an audio device without any DAC, the USB interface 140 may operate in an audio adapter accessory mode, and output an analog audio signal to the audio device 600 for playback. For example, when the multi-media device 100 (such as the SoC 160 and the USB interface 140 therein) operates in the audio adapter accessory mode, the conversion circuit 162 may utilize a DAC therein (not shown) to convert the audio signal received from the display device 200 into an analog audio signal, and further transmit the analog audio signal to the audio device 600 through the USB interface 140 for playback.

In practice, based on the limitation of a length of HDMI cable, the multi-media device 100 is usually arranged at a position near the display device 200. According to user experience, an audio device may need to be arranged at a position having a specific distance from the display device 200 (or the multi-media device 100). In the related art, an audio signal from the display device 200 may be transmitted by optical fibers to overcome the limitation of the length of HDMI cable, but equipment for optical fiber transmission is usually expensive. In comparison with the related art, based on the USB interface 140 within the multi-media device 100 of the present invention, a plurality of cables can be connected in series to connect the USB interface 140 to the audio device (e.g. the audio device 500 shown in FIG. 1) through at least one hub to increase a transmission distance of an audio signal (such as the aforementioned second audio signal) between the multi-media device 100 and the audio device (e.g. the audio device 500 shown in FIG. 1). For example, when a single USB cable is not long enough to satisfy requirements of the video system established by a user, the user may utilize a hub to connect two USB cables (or utilize two or more hubs to connect three or more USB cables) to increase the transmission distance of the audio signal, but the present invention is not limited thereto.

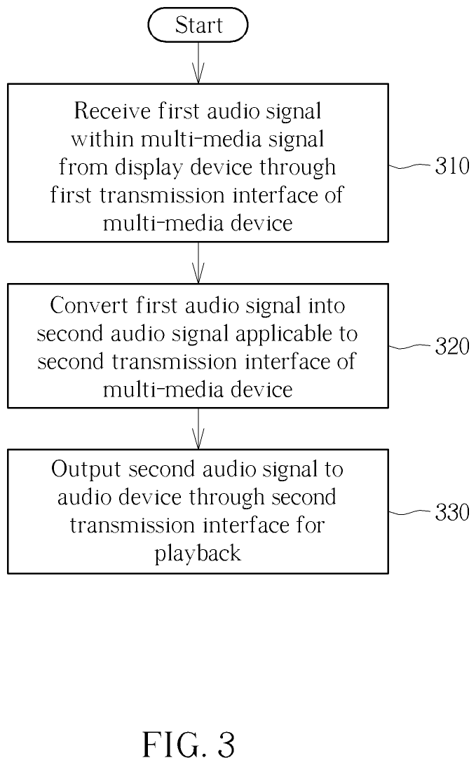

FIG. 3 is a flowchart illustrating a method for processing a multi-media signal (e.g. the streaming data obtained by the display device 200 from a data streaming source in the aforementioned embodiment) according to an embodiment of the present invention. For better comprehension, please refer to FIG. 3 in conjunction with FIG. 1 and FIG. 2.

In Step 310, a first transmission interface such as the HDMI interface 120 of the multi-media device 100 receives a first audio signal within the multi-media signal from the display device 200. More specifically, the HDNI interface 120 may utilize an ARC or an eARC to receive the first audio signal.

In Step 320, the multi-media device 100 (more particularly, the conversion circuit 162 within the SoC 160) converts the first audio signal into a second audio signal applicable to a second transmission interface such as the USB interface 140 of the multi-media device 100.

In Step 330, the multi-media device 100 may output the second audio signal to an audio device through the second transmission interface for playback. Note that, when the multi-media device 100 is coupled to the audio device 500 (as shown in FIG. 1), the second audio signal may comprise a digital audio signal; and when the multi-media device 100 is coupled to the audio device 600 (as shown in FIG. 2), the multi-media 100 (e.g. the USB interface 140) may operate in an audio adapter accessory mode to make the second audio signal comprise an analog audio signal.

Briefly summarized, the method and the multi-media device of the present invention can solve the problems caused by insufficient length of an HDMI cable by converting an audio signal received by the HDMI interface 120 into another audio signal for being outputted by the USB interface 140. In addition, the USB interface 140 is not only for transmitting audio signals, but also for obtaining power from the audio device. According to this power separated design, the size of the multi-media device can be reduced. As mentioned above, the present invention can improve user experience and solve the problem of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing a multi-media signal, comprising:
receiving a first audio signal within the multi-media signal from a display device through a first transmission interface of a multi-media device;
converting the first audio signal into a second audio signal applicable to a second transmission interface of the multi-media device; and
outputting the second audio signal to an audio device through the second transmission interface for playback.

2. The method of claim 1, wherein the first transmission interface comprises a High Definition Multimedia Interface (HDMI), and the step of receiving the first audio signal from the display device through the first transmission interface comprises:
receiving the first audio signal from the display device through an Audio Return Channel (ARC) or an enhanced ARC (eARC).

3. The method of claim 2, wherein the second transmission interface comprises a Universal Serial Bus (USB) interface.

4. The method of claim 3, further comprising:
connecting a plurality of cables in series to connect the USB interface to the audio device through at least one hub, to increase a transmission distance of the second audio signal between the multi-media device and the audio device.

5. The method of claim 3, further comprising:
utilizing the multi-media device to obtain power from a power management circuit within the audio device through at least one cable connecting the USB interface to the audio device.

6. The method of claim 3, wherein the USB interface comprises a USB type-C interface, and the method further comprises:
in an audio adapter accessory mode of the USB type-C interface, outputting the second audio signal to the audio device through the USB type-C interface for playback, wherein the second audio signal comprises an analog audio signal.

7. The method of claim 1, wherein each of the multi-media device and the display device has a function of obtaining streaming data from a data streaming source; and in response to the streaming data being obtained from the data streaming source through the display device rather than through the multi-media device, the multi-media device obtains audio data within the streaming data from the display device, wherein the first audio signal carries the audio data.

8. A multi-media device, comprising:
a first transmission interface, configured to receive a first audio signal within a multi-media signal from a display device;
a second transmission interface, configured to output a second audio signal to an audio device for playback; and
a system chip, comprising a conversion circuit coupled between the first transmission interface and the second transmission interface, wherein the system chip utilizes the conversion circuit to convert the first audio signal into the second audio signal applicable to the second transmission interface.

9. The multi-media device of claim 8, wherein the first transmission interface comprises a High Definition Multimedia Interface (HDMI), and the multi-media device utilizes an Audio Return Channel (ARC) or an enhanced ARC (eARC) therein to receive the first audio signal from the display device.

10. The multi-media device of claim 9, wherein the second transmission interface comprises a Universal Serial Bus (USB) interface.

11. The multi-media device of claim 10, wherein at least one hub connects a plurality of cables in series to connect the USB interface to the audio device, to increase a transmission distance of the second audio signal between the multi-media device and the audio device.

12. The multi-media device of claim 10, wherein the audio device comprises:
a power management circuit, configured to perform power management, wherein the multi-media device obtains power from the power management circuit through at least one cable connecting the USB interface to the audio device.

13. The multi-media device of claim 10, wherein the USB interface comprises a USB type-C interface, and in an audio adapter accessory mode of the USB type-C interface, the USB type-C interface outputs the second audio signal to the audio device for playback, wherein the second audio signal comprises an analog audio signal.

14. The multi-media device of claim 8, wherein each of the multi-media device and the display device has a function of obtaining streaming data from a data streaming source; and in response to the streaming data being obtained from the data streaming source through the display device rather than through the multi-media device, the multi-media device obtains audio data within the streaming data from the display device, wherein the first audio signal carries the audio data.
